(19) United States
(12) Patent Application Publication
(10) Pub. No.: US 2019/0346278 A1
(43) Pub. Date: Nov. 14, 2019

(54) MULTI-FUNCTION PROBE AIR DATA SYSTEM ARCHITECTURE INCLUDING ACOUSTIC SENSORS

(71) Applicant: Rosemount Aerospace Inc., Burnsville, MN (US)

(72) Inventors: Jaime Sly, Savage, MN (US); Brian Brent Naslund, Chanhassen, MN (US)

(21) Appl. No.: 15/975,355

(22) Filed: May 9, 2018

(51) Int. Cl. G01C 23/00; B64D 43/02; G01C 9/00; G01P 5/16

(52) U.S. Cl. CPC G01C 23/00; G01P 5/16; G01C 9/005; B64D 43/02

(57) ABSTRACT

An air data system for an aircraft includes a multi-function probe (MFP) and an acoustic sensor system. The MFP is positioned to sense pressure of an airflow about an exterior of the aircraft. The pressure is used to generate first air data parameters for the aircraft. The acoustic sensor system is configured to emit acoustic signals about the exterior of the aircraft and sense the acoustic signals as sensed data, which is used to generate second air data parameters.

### BACKGROUND

The present disclosure relates generally to air data systems, and more particularly to air data systems utilizing multi-function probes and acoustic sensors for generating aircraft air data parameter outputs.

Modern aircraft often incorporate air data systems that calculate air data outputs based on measured parameters collected from various sensors positioned about the aircraft. For instance, many air data systems utilize air data probes that measure pneumatic pressure of airflow about the aircraft exterior to generate aircraft air data outputs, such as angle of attack (i.e., an angle between the oncoming airflow or relative wind and a reference line of the aircraft, such as a chord of a wing of the aircraft), calibrated airspeed, Mach number, altitude, or other air data parameters. During sideslip of the aircraft (i.e., a nonzero angle between the direction of travel of the aircraft and the aircraft centerline extending through the nose of the aircraft), compensation of various local (to the probe) parameters or signals, such as angle of attack and static pressure, is advantageous for accurate determination of aircraft air data parameters, such as aircraft angle of attack or aircraft pressure altitude (determined from static pressure measurements). The air data probes may also be paired with temperature sensors in order to determine static air temperature, total air temperature, and true airspeed.

Increased accuracy achieved through sideslip compensation is particularly relevant in modern aircraft employing advanced control mechanisms that operate in the National Airspace System, as well as to accommodate fly-by-wire or other control systems that may benefit from increased accuracy achieved through sideslip compensation. To this end, many air data systems utilize multiple pneumatic air data probes positioned at opposite sides of the aircraft and cross-coupled to exchange pressure information. Static pressure sensed by an opposite side probe is used to compensate air data parameter outputs for a sideslip condition. In certain air data systems, cross-coupled probes are pneumatically connected so that the pressure signals are averaged between probes. Other air data systems utilize air data probes that are not pneumatically connected, but rather include processors and other electronic components for interchanging electrical signals representative of the pressure information (and other information) between probes. Such probes, having integrated electronics, are often referred to as electronic multi-function probes (MFPs). MFPs reduce the need for pneumatic couplings between the probes, thereby reducing space, cost, and maintenance associated with the pneumatic couplings.

As aircraft systems such as flight control systems and stall protection systems become more highly integrated, complex, and automated, the integrity of air data information used by these aircraft systems becomes increasingly important. As such, these highly complex systems typically utilize redundant inputs of air data information that are measured by independent sources. The independent sources of air data are often desired to be derived from dissimilar equipment to reduce the risk of common mode errors occurring amongst the separate sources of air data. This redundancy, independence, and dissimilarity of air data outputs is strongly recommended worldwide by certification authorities and is typically required for airworthiness certification of the aircraft.

### SUMMARY

In one example embodiment, an air data system for an aircraft includes a multi-function probe (MFP) and an acoustic sensor system. The MFP is positioned to sense a pressure of an airflow about an exterior of the aircraft. The pressure is used to generate first air data parameters for the aircraft. The acoustic sensor system is configured to emit acoustic signals about the exterior of the aircraft and sense the acoustic signals as sensed data, which is used to generate second air data parameters.

In another example embodiment, a system for an aircraft includes a first MFP, a second MFP, and an acoustic sensor system. The first MFP is configured to sense at least one first pressure of airflow about an exterior of the aircraft and includes a first electronics channel and a second electronics channel. The second MFP is configured to sense at least one second pressure of airflow about the exterior of the aircraft and includes a first electronics channel and a second electronics channel. The first electronics channel of the second MFP is electrically coupled with the first electronics channel of the first MFP to form a first air data system providing first aircraft air data parameter outputs. The second electronics channel of the second MFP is electrically coupled with the second electronics channel of the first MFP to form a second air data system providing second aircraft air data parameter outputs. The acoustic sensor system includes a first emitter configured to emit first acoustic signals into the airflow about the exterior of the aircraft and is configured to sense the first acoustic signals as first sensed data.

In another example embodiment, a method includes generating first aircraft air data parameter outputs from a first electronics channel of a first multi-function probe (MFP) based on pressure of airflow about an aircraft exterior sensed by the first MFP and static pressure data corresponding to static pressure of the airflow about the aircraft exterior received from a first electronics channel of a second MFP; generating second aircraft air data parameter outputs from a second electronics channel of the second MFP based on pressure of the airflow about the aircraft exterior sensed by the second MFP and static pressure data corresponding to static pressure of airflow about the aircraft exterior received from a second electronics channel of the first MFP; and generating third aircraft air data parameter outputs from an acoustic sensor based on observed acoustic signals emitted by the acoustic sensor into airflow about the aircraft exterior.

### BRIEF DESCRIPTION OF THE DRAWINGS

FIG. 1 is a schematic block diagram illustrating an example embodiment of an acoustic sensor system that forms an aircraft air data system.

FIGS. 2A and 2B are schematic diagrams illustrating an aircraft air data architecture according to an embodiment.

FIG. 3 is a schematic diagram illustrating another embodiment of an aircraft air data architecture.

### DETAILED DESCRIPTION

As described herein, an example air data system architecture includes two dual-channel multi-function probes (MFPs) and an acoustic sensor system to provide three independent sets of aircraft air data parameter outputs. A first electronics channel of the first MFP is electrically coupled to receive static pressure data from a first electronics channel of the second MFP to form a first air data system providing first aircraft air data parameter outputs. A second electronics channel of the second MFP is electrically coupled to receive static pressure data from a second electronics channel of the first MFP to form a second air data system providing second aircraft air data parameter outputs.

The acoustic sensor system may form a third air data system providing third aircraft air data parameter outputs. The acoustic sensor system may include multiple acoustic sensors positioned on the aircraft exterior in separate geometric planes. Each acoustic sensor is configured to emit acoustic signals, such as acoustic pulses, for example, into an airflow about the aircraft exterior and to generate the third aircraft air data parameter outputs based on sensed data from microphones positioned to sense the emitted acoustic signals.

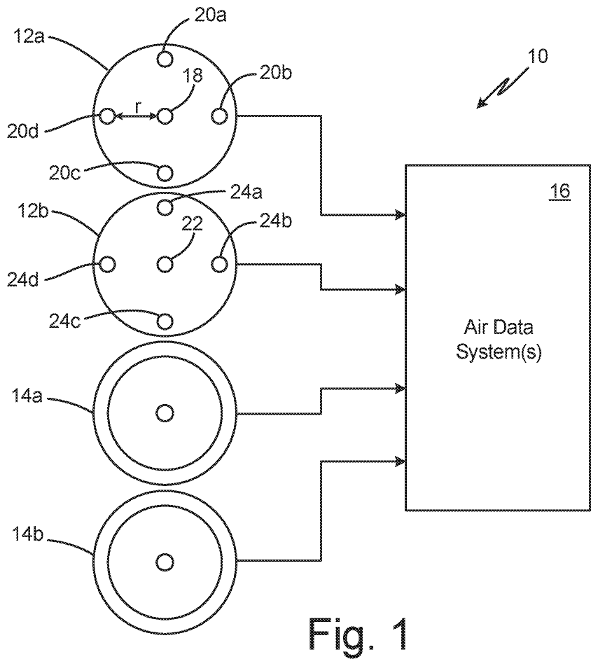

FIG. 1 is a schematic block diagram illustrating an example embodiment of an acoustic sensor system. Acoustic sensor system 10 includes acoustic sensors 12a and 12b, static ports 14a and 14b, and air data system(s) 16. Sensor system 10 can include any combination of sensors 12a and 12b, and static ports 14a and 14b. When including all of sensors 12a and 12b, and static ports 14a and 14b, a full suite of air data parameters is obtainable for an aircraft that includes system 10. For example, acoustic sensor system 10 is capable of determining angle-of-attack (AOA), angle-of-sideslip (AOS), static air temperature (SAT), and static pressure. Acoustic sensor 12a includes emitter 18 and microphones 20a-20d, and acoustic sensor 12b includes emitter 22 and microphones 24a-24d. Air data system(s) 16 may include an air data computer, hosted air data application, or any other system capable of receiving sensed data and generating air data parameters. While illustrated and described as acoustic sensors that include an emitter centered within four microphones, other embodiments of acoustic sensors 12a and 12b may include any configuration capable of emitting and receiving acoustic signals. For example, acoustic sensors 12a and 12b may include fewer or greater than four microphones arranged in any manner to sense acoustic signals from emitters 18 and 22. In other embodiments, one or both of acoustic sensors 12a and 12b may include an array of transducers capable of both emitting and receiving acoustic signals.

An acoustic sensor system implemented on an aircraft may include one or more of acoustic sensors 12a and 12b, and static ports 14a and 14b, in any combination, based upon the needs of the aircraft. For example, an aircraft may include only acoustic sensor 12a, which may be positioned at any point on the exterior of the aircraft. In one embodiment, acoustic sensor 12a may be positioned on the side of the aircraft and emitter 18 may emit acoustic signals into the airflow along the side of the aircraft. Each microphone 20a-20d may be positioned to sense the emitted acoustic signals. In one example embodiments, the acoustic signals may be acoustic pulses emitted at any desired frequency. For example, acoustic sensor 12a may be an ultrasonic acoustic sensor, emitting pulses at greater than 20 kHz. In other embodiments, acoustic sensor 12a may be configured to emit pulses in the audible range. In other embodiments, acoustic sensor 12a may be configured to emit a continuous sound wave rather than pulses.

In the example embodiment illustrated in FIG. 1, microphones 20a and 20c are orthogonal to microphones 20b and 20d. The distance (r) between emitter 18 and each microphone 20a-20d is known. The distance between each microphone 20a-20d and emitter 18 may be equal, or may vary for each microphone 20a-20d. For example, the distance (r) between each microphone 20a-20d and emitter 18 may be between 4 and 5 inches. In this embodiment, if acoustic sensor 12a is an ultrasonic sensor configured to emit acoustic pulses at 40 kHz, it will take on the order of 200 to 5000 microseconds, depending upon airflow and ambient conditions, for each acoustic pulse to reach each microphone 20a-20d.

Knowing the distance (r) between each microphone 20a-20d and emitter 18, time of flight for the acoustic signals can be determined for each microphone 20a-20d. Using two microphones along the same axis, the speed of sound in the direction of the two microphones can be determined. For example, acoustic sensor 12a may be positioned on the right side of the aircraft. For an aircraft in the u-v-w three-dimensional space (e.g., the u axis extends along the body and through the nose of the aircraft, the v axis extends out through the side of the aircraft, and the w axis extends through the bottom of the aircraft), acoustic sensor 12a is positioned in the u-w geometric plane. Thus, microphones 20a and 20c can be used to obtain a velocity in the w axis direction, and microphones 20b and 20d can be used to obtain a velocity in the u axis direction. These two velocities can be used to form a two-dimensional velocity vector for the u-w plane. Because acoustic sensor 12a is on the side of the aircraft, the two-dimensional velocity vector can be used to determine an AOA for the aircraft.

In another embodiment, acoustic sensor 12a may be positioned on the top or bottom of the aircraft. For example, acoustic sensor 12a may be positioned on the top of the aircraft in the geometric u-v plane. In this embodiment, microphones 20a and 20c can be used to determine a velocity in the u axis direction, and microphones 20b and 20d can be used to determine a velocity in the v axis direction. Because acoustic sensor 12a is on the top of the aircraft, the two-dimensional velocity vector for the u-v plane can be used to determine an AOS for the aircraft.

Acoustic sensor 12a is also capable of providing a static air temperature, regardless of the position on the exterior of the aircraft. Two microphones along the same axis, such as microphones 20a and 20c, may be used to sense the acoustic signals from emitter 18. Microphone 20c may sense the time of flight of the acoustic signals upstream of emitter 18 and microphone 20a may sense the time of flight of the acoustic signals downstream of emitter 18. Knowing the distance between microphones 20a and 20c, the speed of sound may be determined, which can then be used to calculate the air temperature. Thus, an aircraft system that includes only a single acoustic sensor is capable of providing parameter outputs that include a two-dimensional velocity vector and a static air temperature. The two-dimensional velocity vector can be used to determine either AOA or AOS, depending upon the physical location of the acoustic sensor on the aircraft.

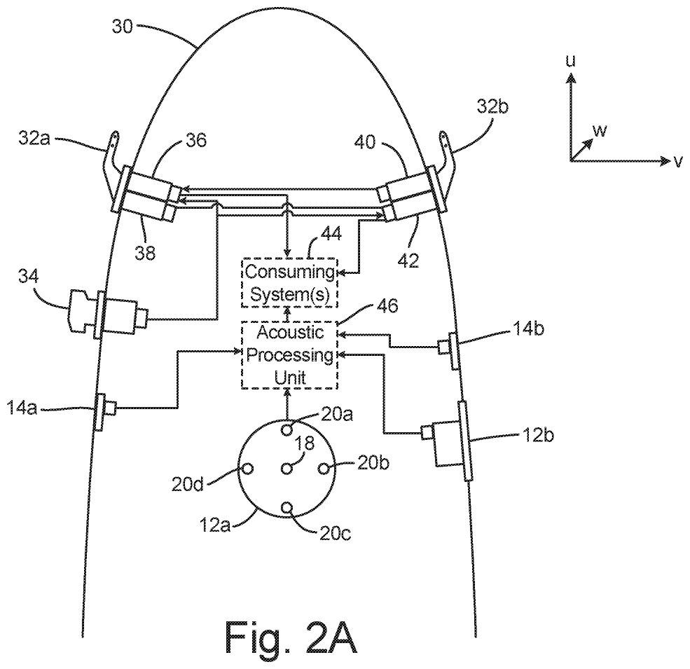

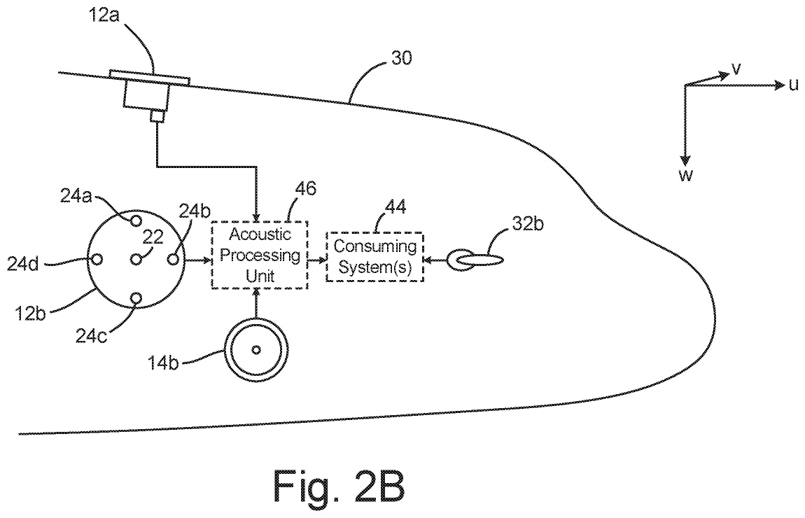

In another embodiment, in addition to the first acoustic sensor 12a, a second acoustic sensor 12b may be positioned on the aircraft in a geometric plane different from acoustic sensor 12a. For example, and as illustrated in FIG. 2A, the first acoustic sensor 12a may be implemented on the top or bottom of the aircraft in the u-v plane, while the second acoustic sensor 12b may be implemented on the side of the aircraft in the u-w plane. Acoustic sensor 12b may operate in a substantially similar manner to acoustic sensor 12a. Acoustic sensor 12a is capable of obtaining the two-dimensional velocity vector in the u-v plane and acoustic sensor 12b is capable of obtaining a two-dimensional velocity vector in the u-w plane. The two two-dimensional velocity vectors from the two respective acoustic sensors 12a and 12b allow the acoustic system to determine both AOA and AOS.

In addition to one or both of acoustic sensors 12a and 12b, one or both of static pressure ports 14a and 14b may be included on the exterior of the aircraft. For example, static pressure port 14a may be positioned on the left side of the aircraft and static pressure port 14b may be positioned on the right side of the aircraft to sense static pressure. Therefore, using acoustic sensors 12a and 12b, and static pressure ports 14a and 14b, air data systems 16 can generate a full suite of aircraft air data parameters. In other embodiments, acoustic sensors 12a and 12b may include integrated static pressure ports, or may be configured to determine static pressure acoustically, eliminating the need for separate static ports 14a and 14b.

FIGS. 2A and 2B are schematic block diagrams illustrating an example air data system architecture for aircraft 30 that includes acoustic sensors 12a and 12b, static ports 14a and 14b, first MFP 32a, second MFP 32b, and TAT sensor 34. FIG. 2A is a top-down view of aircraft 30 in the u-v plane and FIG. 2B is a side view of aircraft 30 in the u-w plane. FIGS. 2A and 2B will be discussed together. First MFP 32a includes first electronics channel 36 and second electronics channel 38. Second MFP 32b includes first electronics channel 40 and second electronics channel 42. Each of first electronics channel 36 and second electronics channel 42 includes a plurality of pressure sensors and processing circuitry for determining air data parameter outputs based on measured pressures of the airflow, as is further described below. Each of second electronics channel 38 and first electronics channel 40 includes a pressure sensor and processing circuitry for determining a static air pressure of the airflow.

TAT sensor 34 includes one or more temperature sensing elements and conditioning circuitry for sensing total air temperature of airflow about the exterior of aircraft 30. Acoustic sensor 12a includes emitter 18 configured to emit acoustic signals into the airflow and microphones 20a-20d are positioned and configured to sense the acoustic signals from emitter 18. Acoustic sensor 12b includes emitter 22 configured to emit acoustic signals into the airflow and microphones 24a-24d are positioned and configured to sense the acoustic signals from emitter 22.

As illustrated in FIG. 2A, first electronics channel 36 of first MFP 32a is electrically coupled with first electronics channel 40 of second MFP 32b to form a first air data system that provides first aircraft air data parameter outputs. Second electronics channel 42 of second MFP 32b is electrically coupled with second electronics channel 38 of first MFP 32a to form a second air data system that provides second aircraft air data parameter outputs. Acoustic sensors 12a and 12b, and static ports 14a and 14b form a third air data system that provides third aircraft air data parameter outputs that are generated based in part upon time of flight measurements of the acoustic signals emitted by emitter 18, as discussed above. TAT sensor 34 is electrically coupled with each of first electronics channel 36 and second electronics channel 42 to provide total air temperature data corresponding to measured total air temperature of the airflow to each of first electronics channel 36 and second electronics channel 42. While illustrated in FIG. 2A as including all of acoustic sensors 12a and 12b, and static ports 14a and 14b, aircraft 30 may include any combination of acoustic sensors 12a and/or 12b, and/or static ports 14a and/or 14b.

Each of first electronics channel 36, second electronics channel 42, and acoustic processing unit 46 are electrically coupled to send (and, in some examples, receive) data with consuming system(s) 44. Consuming systems 44 can include aircraft systems, such as flight management systems, auto-flight control systems, standby instrument systems, display systems, data concentrator units, or other consuming systems of air data parameter outputs. Electrical couplings illustrated in FIGS. 2A and 2B can take the form of direct electrical couplings and/or data bus couplings configured to communicate according to one or more communication protocols, such as the Aeronautical Radio, Incorporated (ARINC) 429 communication protocol, controller area network (CAN) bus communication protocol, military standard 1553 (MIL-STD-1553) communication protocol, Ethernet, or other analog or digital communication protocols.

Acoustic processing unit 46 may be any computer, microprocessor, controller, or other digital circuit configured to calculate air data parameters based on sensed data from acoustic sensors 12a and 12, and static ports 14a and 14b. In the embodiment illustrated in FIGS. 2A and 2B, sensed analog data is provided to acoustic processing unit 46, which converts the analog data into digital data, and calculates the air data parameters using the digital data. The air data parameter outputs from acoustic processing unit 46 are provided to consuming systems 44. In other embodiments, acoustic sensors 12a and 12b, and/or static ports 14a and 14b may include local processing circuitry to supplement and/or eliminate the need for acoustic processing unit 46. For example, acoustic sensor 12a may include a local processor such that data from acoustic sensor 12b and static ports 14a and 14b can be provided to the local processor of acoustic sensor 12a for calculation of the third air data parameter outputs. The local processor of acoustic sensor 12a can then provide the third air data parameter outputs directly to consuming systems 44.

In operation, each of first electronics channel 36 of first MFP 32a and second electronics channel 42 of second MFP 32b measures pressure of an airflow via a plurality of pressure sensing ports, such as a total pressure sensing port and two alpha pressure sensing ports disposed in a barrel portion of first MFP 32a and second MFP 32b, respectively. Second electronics channel 38 of first MFP 32a and first electronics channel 40 of second MFP 32b each measure static pressure of the airflow via a static pressure sensing port disposed in the barrel portion aft of the alpha pressure sensing ports of first MFP 32a and second MFP 32b, respectively. TAT sensor 34 senses total air temperature of the airflow and provides total air temperature data corresponding to the measured total air temperature to each of first electronics channel 36 and second electronics channel 42.

First electronics channel 36 generates local air data parameters (i.e., local to first MFP 32a) based on the measured pressures from the plurality of measured pressure sensors of first MFP 32a and the total air temperature data received from TAT sensor 34. Examples of local air data parameters include, but are not limited to, local AOA, local static pressure, local calibrated airspeed, local Mach number, and local pressure altitude.

Static pressure data corresponding to static pressure measured by first electronics channel 40 of second MFP 32b is communicated to first electronics channel 36 of first MFP 32a. First electronics channel 36 compensates (e.g., modifies) the generated local air data parameters based on functional relationships between static pressure data received from first electronics channel 40 of second MFP 32b and the generated local air data parameters to produce compensated aircraft air data parameters. For example, first electronics channel 36 can store one or more functional mappings that relate local air data parameter values to aircraft air data parameter values as a function of static pressure data received from first electronics channel 40 of second MFP 32b. Functional mappings can take the form of one or more mathematical relationships, one or more data lookup tables, or other functional mappings. First electronics channel 36 can compensate the generated local air data parameters according to the functional mappings to generate compensated aircraft air data parameter values that are provided to consuming systems 44.

In other examples, the one or more functional mappings can relate local air data parameters to aircraft air data parameter values as a function of aircraft AOS. In such examples, first electronics channel 36 can determine an aircraft AOS as a function of local total pressure, local static pressure, and local impact pressure (determined from measured pressures of first MFP 32a) as well as static pressure data received from first electronics channel 40 of second MFP 32b. First electronics channel 36 can compensate the generated local air data parameter values based on the determined aircraft AOS according to the functional mappings to generate compensated aircraft air data parameter outputs that are provided to consuming systems 44. Aircraft air data parameter outputs can include, e.g., aircraft static pressure, aircraft calculated airspeed, aircraft true airspeed, aircraft Mach number, aircraft pressure altitude, aircraft AOA, aircraft AOS, or other aircraft air data parameters outputs.

Accordingly, first electronics channel 36 of first MFP 32a that is electrically coupled with first electronics channel 40 of second MFP 32b forms a first air data system that provides first aircraft air data parameter outputs to consuming systems 44. Second electronics channel 42 of second MFP 32b that is electrically coupled with second electronics channel 38 of first MFP 32a forms a second air data system that provides second aircraft air data parameter outputs to consuming systems 44. That is, second electronics channel 42 generates local air data parameters (i.e., local to second MFP 32b) based on measured pressures from the plurality of measured pressure sensors of second MFP 32b and the total air temperature data received from TAT sensor 34. Static pressure data corresponding to static pressure measured by second electronics channel 38 of first MFP 32a is communicated to second electronics channel 42 of second MFP 32b. Second electronics channel 42 compensates (e.g., modifies) the generated local air data parameters based on functional relationships between static pressure data received from second electronics channel 38 of first MFP 32a (or, in certain examples, aircraft angle of sideslip) and the generated local air data parameters to produce compensated aircraft air data parameters. Compensated aircraft air data parameters generated by second electronics channel 42 of second MFP 32b are provided to consuming systems 44.

Acoustic sensors 12a and 12b, and static pressure ports 14a and 14b, as described above, form the third air data system for aircraft 30 that provides third aircraft air data parameters based on sensing of acoustic signals emitted by sensors 12a and 12b. Local flow calibration may be performed for the acoustic system by acoustic processing unit 46, or by other software implemented elsewhere on aircraft 30. The first aircraft air data parameter outputs provided by the first air data system (e.g., formed by first electronics channel 36 and first electronics channel 40), the second aircraft air data parameter outputs provided by the second air data system (e.g., formed by second electronics channel 42 and second electronics channel 38), and the third aircraft air data parameter outputs provided by the third air data system (e.g., formed by acoustic sensors 12a and 12b, and static pressure ports 14a and 14b) can include the same air data parameters. As such, an air data system architecture according to techniques described herein can provide three independent sets of redundant air data parameter outputs for use by, e.g., consuming systems 44.

While illustrated as three separate air data systems in FIGS. 2A and 2B, other embodiments may include a single MFP 32a or 32b together with the acoustic data system. For example, an aircraft may include one MFP 32a and one acoustic sensor 12a. Other embodiments may include two or more MFPs 32a and 32b and one acoustic sensor 12a or 12b, one MFP 32a or 32b and two or more acoustic sensors 12a and 12b, or any other combination of components illustrated and described with respect to FIGS. 2A and 2B.

Consuming systems 44, in some examples, utilize each of the first aircraft air data parameter outputs, the second aircraft air data parameter outputs, and the third aircraft air data parameter outputs, alone or in combination, as part of a primary aircraft air data set. For instance, one or more of consuming systems 44 (e.g., a flight management system, an auto-flight control system, or any one or more other consuming systems) can utilize each of the first aircraft air data parameter outputs, the second aircraft air data parameter outputs, and the third aircraft air data parameter outputs in a voting scheme to select one or more of the first, second, and/or third air data parameter outputs for active use by consuming systems 44.

In some examples, one or more of consuming systems 44 can identify the presence of a failure condition in one or more of the first air data system, the second air data system, and the third air data system based on a comparison of the first aircraft air data parameter outputs, the second aircraft air data parameter outputs, and the third aircraft air data parameter outputs. For instance, in examples where only two of the first, second, and third aircraft air data parameter outputs agree (e.g., include parameter output values that are within a threshold deviation), consuming systems 44 can identify the presence of a failure condition in the remaining one of the first, second, and third air data systems that provides air data parameter outputs that do not agree (e.g., includes parameter output values that are not within the threshold deviation from the remaining two systems). Consuming systems 44 can refrain from utilizing air data parameter outputs from the identified air data system having the failure condition, thereby increasing integrity of the air data parameter outputs utilized for, e.g., flight control functions of aircraft 30. In addition, consuming systems 44 can, in certain examples, store, annunciate, or otherwise indicate the presence of the failure condition in the identified air data system, thereby facilitating maintenance operations on components of the identified air data system having the failure condition.

In some examples, consuming systems 44 include one or more standby (or backup) instruments or components, such as a standby flight display unit, that are utilized by flight control systems, pilots, or other systems in the event of a failure condition of designated primary air data system components. In certain examples, one or more of the first aircraft air data parameter outputs, the second aircraft air data parameter outputs, and the third aircraft air data parameter outputs can be provided to the standby instruments or components for use by, e.g., a pilot, in the event of degraded operation of designated primary instruments and/or components. For instance, the third aircraft air data parameter outputs provided by the third air data system (e.g., formed by acoustic sensors 12a and 12b, and static ports 14a and 14b) can be provided to the standby instruments or components.

As such, an air data system architecture implementing techniques described herein provides three independent air data systems formed by two dual-channel MFPs (i.e., first MFP 32a and second MFP 32b) and an acoustic sensor system that includes acoustic sensors 12a and 12b and static ports 14a and 14b. Acoustic technology provided by acoustic sensors 12a and 12b used to form the third air data system provides aircraft air data parameter outputs using dissimilar measurements as compared with the pneumatic-based measurements of the MFPs. Accordingly, techniques of this disclosure can help to increase dissimilarity of the air data systems, reducing the impact of common-mode failures of the pneumatic systems (e.g., MFPs 32a and 32b). For example, the acoustic system may be flush or semi-flush to the skin of the aircraft, reducing the impact of icing conditions experienced by the pneumatic systems.

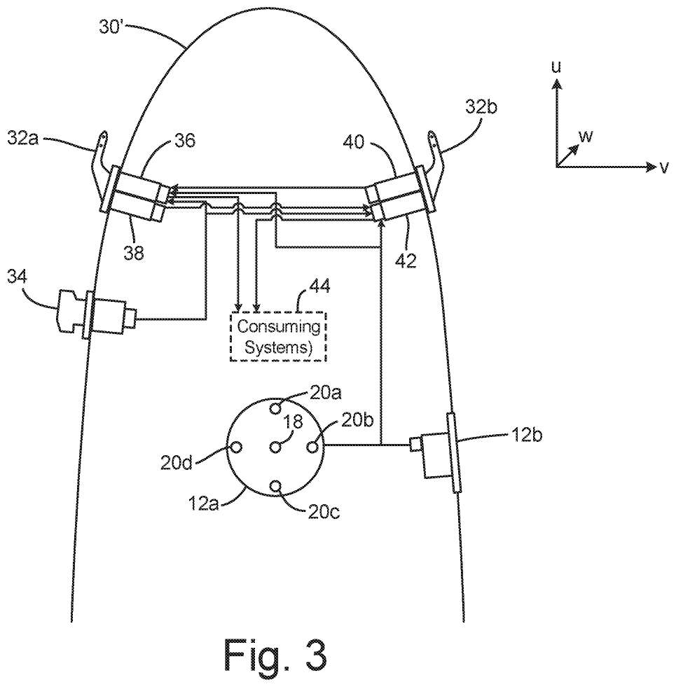

FIG. 3 is a schematic diagram illustrating another example air data system architecture for aircraft 30′ including acoustic sensors 12a and 12b, first MFP 32a, second MFP 32b, and TAT sensor 34. In the embodiment illustrated in FIG. 3, acoustic sensors 12a and 12b do not act as a third air data system, but rather are connected to provide data directly to both the first channel 36 of first MFP 32a, and the second channel 42 of second MFP 32b. In this embodiment, rather than being a third air data system, the sensed data from acoustic sensors 12a and 12b can be used by the first and second air data systems for performance enhancement and fault detection.

For example, aircraft 30′ may experience a sideslip condition where the path of travel of aircraft 30′ is not in line with the u axis (i.e., the axis extending through the nose of the aircraft is at an angle with the direction of travel of the aircraft). In operation, as air flows over the exterior of aircraft 30′, first MFP 32a and second MFP 32b generate local air data parameters (i.e., corresponding to the local conditions of the respective one of first MFP 32a and second MFP 32b) based on sensed pressure data.

In a sideslip condition, first MFP 32a experiences different flow conditions than those experienced by second MFP 32b. For instance, in the sideslip condition in which the nose of aircraft 30′ is pointing left of the direction of flight, second MFP 32b experiences airflow having higher pressure conditions than those experienced by first MFP 32a due to the acceleration of the airflow about the aircraft exterior prior to reaching first MFP 32a. Accordingly, the first electronics channel of first MFP 32a is electrically coupled with the first electronics channel of second MFP 32b to receive static pressure data corresponding to static pressure sensed by second MFP 32b via the static pressure port pneumatically connected to a pressure sensor of the first electronics channel of second MFP 32b.

The first electronics channel of first MFP 32a determines an AOS of aircraft 30′ as a function of the received static pressure data and compensates the determined local air data parameters based on the AOS to provide the first aircraft air data parameter outputs. Similarly, the second electronics channel of second MFP 32b is electrically coupled with the second electronics channel of first MFP 32a to receive static pressure data corresponding to static pressure sensed by first MFP 32a via the static pressure port pneumatically connected to a pressure sensor of the second electronics channel of first MFP 32a. The second electronics channel of second MFP 32b determines an AOS of aircraft 30′ as a function of the received static pressure data and compensates the determined local air data parameters based on the AOS to provide second aircraft air data parameter outputs.

In the event that either MFP 32a or MFP 32b becomes unavailable for any reason, the remaining working MFP can use sensed data from acoustic sensors 12a and 12b to perform compensation otherwise performed using the cross-side probe. This way, rather than acting as a third air data system, acoustic sensors 12a and 12b may be used to provide redundant data and fault accommodation for the first and second air data systems.

### Discussion of Possible Embodiments

The following are non-exclusive descriptions of possible embodiments of the present invention.

An air data system for an aircraft includes a first multi-function probe (MFP) and an acoustic sensor system. The first MFP is positioned to sense at least one first pressure of an airflow about an exterior of the aircraft. The at least one first pressure is used to generate first air data parameters for the aircraft. The acoustic sensor system is configured to emit acoustic signals about the exterior of the aircraft and sense the acoustic signals as sensed data, which is used to generate second air data parameters.

The air data system of the preceding paragraph can optionally include, additionally and/or alternatively, any one or more of the following features, configurations and/or additional components:

A further embodiment of the foregoing system, further including a second MFP configured to sense at least one second pressure of the airflow about the exterior of the aircraft, wherein the at least one second pressure is used to generate third air data parameters.

A further embodiment of any of the foregoing systems, wherein the first MFP includes first and second electronics channels, and the second MFP includes first and second electronics channels, and wherein the first electronics channel of the second MFP is electrically coupled to the first electronics channel of the first MFP to form a first air data system configured to generate the first air data parameters, and wherein the second electronics channel of the first MFP is electrically coupled to the second electronics channel of the second MFP to form a second air data system configured to generate the third air data parameters.

A further embodiment of any of the foregoing systems, further including an acoustic processing unit configured to receive the sensed data from the acoustic sensor system and generate the second air data parameters based on the sensed data.

A further embodiment of any of the foregoing systems, wherein each of the first air data parameters, the second air data parameters, and the third air data parameters are provided to consuming systems of the aircraft.

A further embodiment of any of the foregoing systems, wherein the acoustic sensor system includes a first acoustic sensor that includes an emitter, and first, second, third, and fourth microphones, wherein the first and second microphones are orthogonal to the third and fourth microphones.

A further embodiment of any of the foregoing systems, wherein the acoustic sensor system further includes a second acoustic sensor, wherein the first acoustic sensor is positioned on the exterior of the aircraft and lies in a first geometric plane, and the second acoustic sensor is positioned on the exterior of the aircraft and lies in a second geometric plane, different from the first geometric plane.

A further embodiment of any of the foregoing systems, wherein the second air data parameters include one or more of angle of attack, angle of sideslip, an airspeed, and an air temperature.

A further embodiment of any of the foregoing systems, wherein the first and second acoustic sensors are ultrasonic acoustic sensors, and wherein the acoustic signal comprises acoustic pulses.

A further embodiment of any of the foregoing systems, wherein the acoustic sensor system further includes at least one static port positioned to sense a third pressure of an airflow about an exterior of the aircraft

A system for an aircraft includes a first MFP, a second MFP, and an acoustic sensor system. The first MFP is configured to sense at least one first pressure of airflow about an exterior of the aircraft and includes a first electronics channel and a second electronics channel. The second MFP is configured to sense at least one second pressure of airflow about the exterior of the aircraft and includes a first electronics channel and a second electronics channel. The first electronics channel of the second MFP is electrically coupled with the first electronics channel of the first MFP to form a first air data system providing first aircraft air data parameter outputs. The second electronics channel of the second MFP is electrically coupled with the second electronics channel of the first MFP to form a second air data system providing second aircraft air data parameter outputs. The acoustic sensor system includes a first emitter configured to emit first acoustic signals into the airflow about the exterior of the aircraft and is configured to sense the first acoustic signals as first sensed data.

The system of the preceding paragraph can optionally include, additionally and/or alternatively, any one or more of the following features, configurations and/or additional components:

A further embodiment of the foregoing system, wherein the first sensed data is provided to the first air data system and the second air data system to supplement the first aircraft air data parameter outputs and the second aircraft air data parameter outputs.

A further embodiment of any of the foregoing systems, wherein the acoustic sensor system includes an acoustic processing unit, and first and second static pressure ports configured to sense a third pressure of airflow about an exterior of the aircraft, the acoustic sensor system forms a third air data system and the acoustic processing unit is configured to generate third aircraft air data parameter outputs based on the first sensed data.

A further embodiment of any of the foregoing systems, wherein the acoustic sensor system further includes a second emitter configured to emit second acoustic signals into the airflow about the exterior of the aircraft and is configured to sense the second acoustic signals as second sensed data, wherein the first emitter and the second emitter are positioned in different geometric planes.

A further embodiment of any of the foregoing systems, wherein the acoustic processing unit is configured to calculate one or more of angle of sideslip, angle of attack, an airspeed, and an air temperature for the aircraft based on the first and second sensed data.

A further embodiment of any of the foregoing systems, wherein each of the first aircraft air data parameter outputs, the second aircraft air data parameter outputs, and the third aircraft air data parameter outputs comprise a same set of air data parameters.

A further embodiment of any of the foregoing systems, wherein the first MFP is positioned at a first side of the aircraft, the second MFP is positioned at a second side of the aircraft opposite the first side, the first electronics channel of the first MFP is configured to receive static pressure data received from the first electronics channel of the second MFP, and the second electronics channel of the second MFP is configured to receive static pressure data received from the second electronics channel of the second MFP.

A further embodiment of any of the foregoing systems, further including a total air temperature sensor electrically coupled with each of the first electronics channel of the first MFP and the second electronics channel of the second MFP to provide total air temperature measurement data to each of the first electronics channel of the first MFP and the second electronics channel of the second MFP.

A method includes generating first aircraft air data parameter outputs from a first electronics channel of a first multi-function probe (MFP) based on pressure of airflow about an aircraft exterior sensed by the first MFP and static pressure data corresponding to static pressure of the airflow about the aircraft exterior received from a first electronics channel of a second MFP; generating second aircraft air data parameter outputs from a second electronics channel of the second MFP based on pressure of the airflow about the aircraft exterior sensed by the second MFP and static pressure data corresponding to static pressure of airflow about the aircraft exterior received from a second electronics channel of the first MFP; and generating third aircraft air data parameter outputs from an acoustic sensor based on observed acoustic signals emitted by the acoustic sensor into airflow about the aircraft exterior.

A further embodiment of the foregoing method, further including determining the presence of a failure condition of one or more of the first MFP, the second MFP, and the acoustic sensor based on a comparison of the first aircraft air data parameter outputs, the second aircraft air data parameter outputs, and the third aircraft air data parameter outputs.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An air data system for an aircraft, the system comprising:
a first multi-function probe (MFP) positioned to sense at least one first pressure of an airflow about an exterior of the aircraft, wherein the at least one first pressure is used to generate first air data parameters for the aircraft; and
an acoustic sensor system configured to emit acoustic signals about the exterior of the aircraft and sense the acoustic signals as sensed data, wherein the sensed data is used to generate second air data parameters.

2. The air data system of claim 1, further comprising:
a second MFP configured to sense at least one second pressure of the airflow about the exterior of the aircraft, wherein the at least one second pressure is used to generate third air data parameters.

3. The air data system of claim 2, wherein the first MFP includes first and second electronics channels, and the second MFP includes first and second electronics channels, and wherein the first electronics channel of the second MFP is electrically coupled to the first electronics channel of the first MFP to form a first air data system configured to generate the first air data parameters, and wherein the second electronics channel of the first MFP is electrically coupled to the second electronics channel of the second MFP to form a second air data system configured to generate the third air data parameters.

4. The air data system of claim 3, further comprising:
an acoustic processing unit configured to receive the sensed data from the acoustic sensor system and generate the second air data parameters based on the sensed data.

5. The air data system of claim 4, wherein each of the first air data parameters, the second air data parameters, and the third air data parameters are provided to consuming systems of the aircraft.

6. The air data system of claim 1, wherein the acoustic sensor system comprises:
a first acoustic sensor that includes an emitter, and first, second, third, and fourth microphones, wherein the first and second microphones are orthogonal to the third and fourth microphones.

7. The air data system of claim 1, wherein the acoustic sensor system comprises:
a first acoustic sensor; and
a second acoustic sensor;
wherein the first acoustic sensor is positioned on the exterior of the aircraft and lies in a first geometric plane, and the second acoustic sensor is positioned on the exterior of the aircraft and lies in a second geometric plane, different from the first geometric plane.

8. The air data system of claim 7, wherein the second air data parameters include one or more of angle of attack, angle of sideslip, an airspeed, and an air temperature.

9. The air data system of claim 7, wherein the first and second acoustic sensors are ultrasonic acoustic sensors, and wherein the acoustic signal comprises acoustic pulses.

10. The air data system of claim 7, wherein the acoustic sensor system further comprises:
at least one static port positioned to sense a third pressure of an airflow about an exterior of the aircraft.

11. A system for an aircraft, the system comprising:
a first multi-function probe (MFP) configured to sense at least one first pressure of airflow about an exterior of the aircraft, the first MFP having a first electronics channel and a second electronics channel;
a second MFP configured to sense at least one second pressure of airflow about the exterior of the aircraft, the second MFP having a first electronics channel and a second electronics channel, the first electronics channel of the second MFP electrically coupled with the first electronics channel of the first MFP to form a first air data system providing first aircraft air data parameter outputs, the second electronics channel of the second MFP electrically coupled with the second electronics channel of the first MFP to form a second air data system providing second aircraft air data parameter outputs; and
an acoustic sensor system that includes a first emitter configured to emit first acoustic signals into the airflow about the exterior of the aircraft and is configured to sense the first acoustic signals as first sensed data.

12. The system of claim 11, wherein the first sensed data is provided to the first air data system and the second air data system to supplement the first aircraft air data parameter outputs and the second aircraft air data parameter outputs.

13. The system of claim 11, wherein:
the acoustic sensor system includes an acoustic processing unit, and first and second static pressure ports configured to sense a third pressure of airflow about an exterior of the aircraft;
the acoustic sensor system forms a third air data system; and
the acoustic processing unit is configured to generate third aircraft air data parameter outputs based on the first sensed data.

14. The system of claim 13, wherein the acoustic sensor system further includes a second emitter configured to emit second acoustic signals into the airflow about the exterior of the aircraft and is configured to sense the second acoustic signals as second sensed data, wherein the first emitter and the second emitter are positioned in different geometric planes.

15. The system of claim 14, wherein the acoustic processing unit is configured to calculate one or more of angle of sideslip, angle of attack, an airspeed, and an air temperature for the aircraft based on the first and second sensed data.

16. The system of claim 13, wherein each of the first aircraft air data parameter outputs, the second aircraft air data parameter outputs, and the third aircraft air data parameter outputs comprise a same set of air data parameters.

17. The system of claim 11, wherein:
the first MFP is positioned at a first side of the aircraft;
the second MFP is positioned at a second side of the aircraft opposite the first side;
the first electronics channel of the first MFP is configured to receive static pressure data received from the first electronics channel of the second MFP; and
the second electronics channel of the second MFP is configured to receive static pressure data received from the second electronics channel of the second MFP.

18. The system of claim 11, further comprising:
a total air temperature sensor electrically coupled with each of the first electronics channel of the first MFP and the second electronics channel of the second MFP to provide total air temperature measurement data to each of the first electronics channel of the first MFP and the second electronics channel of the second MFP.

19. A method comprising:
generating first aircraft air data parameter outputs from a first electronics channel of a first multi-function probe (MFP) based on pressure of airflow about an aircraft exterior sensed by the first MFP and static pressure data corresponding to static pressure of the airflow about the aircraft exterior received from a first electronics channel of a second MFP;
generating second aircraft air data parameter outputs from a second electronics channel of the second MFP based on pressure of the airflow about the aircraft exterior sensed by the second MFP and static pressure data corresponding to static pressure of airflow about the aircraft exterior received from a second electronics channel of the first MFP; and
generating third aircraft air data parameter outputs from an acoustic sensor based on observed acoustic signals emitted by the acoustic sensor into airflow about the aircraft exterior.

20. The method of claim 19, further comprising:
determining the presence of a failure condition of one or more of the first MFP, the second MFP, and the acoustic sensor based on a comparison of the first aircraft air data parameter outputs, the second aircraft air data parameter outputs, and the third aircraft air data parameter outputs.
